(19) United States
(12) Patent Application Publication
(10) Pub. No.: US 2024/0180126 A1
(43) Pub. Date: Jun. 6, 2024

(54) Inspenser Apparatus and Related Methods

(71) Applicant: Best for Bees Ltd., Kitchener (CA)

(72) Inventor: Erica Leigh SHELLEY, Kitchener (CA)

(73) Assignee: Best for Bees Ltd., Kitchener, ON (CA)

(21) Appl. No.: 18/436,158

(22) Filed: Feb. 8, 2024

Related U.S. Application Data
(63) Continuation of application No. PCT/CA2021/051136, filed on Aug. 17, 2021.

(51) Int. Cl. A01K 51/00

(52) U.S. Cl. CPC A01K 51/00

(57) ABSTRACT

An inspenser, an apparatus, and a method for managing bees of a hive housing having an opening is disclosed. The inspenser includes a body having one or more channels for fluid communication with the opening, and an inlet and an outlet each permitting movement of bees between an environment and the one or more channels. A surface for receiving an additive is within the one or more channels, with the surface being proximate to an expected incoming path travelled by bees entering the one or more channels via the inlet. The inspenser further includes a deflector, positioned between the inlet and the outlet, inhibiting bees moving along the expected incoming path from entering the outlet.

### CROSS-REFERENCE TO RELATED APPLICATION(S)

This application is a Continuation PCT Application No. PCT/CA2021/051136 filed Aug. 17, 2021, the contents of which are incorporated herein by reference in their entirety.

### TECHNICAL FIELD

The following relates to inspenser apparatuses for providing additives into honeybee hives.

### BACKGROUND

Global populations of bees have been declining, due to the increased use of pesticides, an increase in environmental stresses, loss of habitat, and transmission of pests and diseases between social and solitary bee populations.

Current methods of honeybee health management include beekeepers opening the housing containing the hive and providing maintenance directly to the hive. These existing health management practices are cumbersome, introduce additional risk due to opening the housing containing the hive body to the environment, and are labor and time intensive.

There remains a need for improved bee health management techniques, which may address at least one of the above-noted disadvantages.

### SUMMARY OF THE DESCRIPTION

Apivectoring is a technique wherein bees are employed to deliver a protective powder during the course of their travels to protect crops from pests and disease.

In one aspect, an inspenser for delivering additive via bees, the inspenser operable with a hive housing comprising an opening, is disclosed. The inspenser includes a body having one or more channels for fluid communication with the opening, and an inlet and an outlet each permitting movement of bees between an environment and the one or more channels. A surface for receiving an additive is within the one or more channels, with the surface being proximate to an expected incoming path travelled by bees entering the one or more channels via the inlet. The inspenser further includes a deflector, positioned between the inlet and the outlet, inhibiting bees moving along the expected incoming path from entering the outlet.

In another aspect, an apparatus for managing bees of a hive housing having an opening is disclosed. The apparatus includes a body including a cavity in fluid communication with the opening, and an inlet and an outlet, opposite the opening, respectively permitting movement of bees from ambient air into the cavity and permitting movement of bees from the opening out of the cavity. The apparatus further includes a surface for receiving an additive. The surface is proximate to the inlet and includes a lip downstream of the inlet relative to the expected incoming path.

In another aspect, a method for managing bees associated with a hive housing, the hive housing comprising at least in part an opening is disclosed. The method includes installing an inspenser for fluid communication with the opening, the inspenser including an inlet and an outlet in removably inserted into the inspenser. The outlet from the inspenser is removed. A second inlet into the inspenser for encouraging bees to enter the hive housing is inserted in place of the removed outlet.

### BRIEF DESCRIPTION OF THE DRAWINGS

The present description is illustrated by way of example only with reference to the appended drawings wherein:

FIG. 1A is a perspective view of an example inspenser in a partially assembled configuration.

FIG. 1B is another perspective view of the example inspenser of FIG. 1A.

FIG. 1C is perspective view of another example inspenser.

FIG. 2A is a rear perspective view of the example inspenser of FIG. 1 in a disassembled configuration.

FIG. 2B is a rear view of the example inspenser of FIG. 1 in an assembled configuration.

FIG. 3 is a front view of an example removable inlet of the example inspenser of FIG. 1.

FIG. 4 is a front view of an example removable outlet of the example inspenser of FIG. 1.

FIG. 5 is a perspective cross-sectional view of the example inspenser of FIG. 1 along axis A-A′.

FIG. 6 is a perspective view of yet another example inspenser.

FIG. 7A perspective view of an example hive housing.

FIG. 7B is a perspective view of an example system for managing bees.

FIG. 7C is a perspective view of another example system for managing bees, including the hive housing of FIG. 7B and a further example inspenser.

FIG. 8A is a perspective view of another example inspenser.

FIG. 8B is a perspective view of a further example system for managing bees including the example inspenser in FIG. 8A.

FIG. 9 is a top view of a disassembled example inspenser.

FIG. 10 is a perspective view of part of the inspenser of FIG. 10 in a partially assembled configuration.

FIGS. 11A to 11D illustrate various views of an example inspenser.

FIG. 12 is a block diagram for an example method of installing an example inspenser.

FIG. 13 is a block diagram for another example method of installing an example inspenser.

FIG. 14 is a graph showing experimental data of additive movement into a hive housing having an installed preferred inspenser.

FIG. 15 is a graph showing experimental data of bee movement into and out of a hive housing having an installed preferred inspenser.

### DETAILED DESCRIPTION OF THE DRAWINGS

Hereinafter, the term inspenser refers to a mechanism that is used to enact a process or method of delivering substances into the beehive via apivectoring.

Inspenser apparatuses and related methods according to the present disclosure may provide an advantageous method of delivering substances or additives or otherwise which have health benefits for bees, including honeybees, (e.g., Apis mellifera and Apis cerana, and hereinafter referred to as simply bees) within a hive housing.

The inspenser apparatus includes a body defining an interior cavity that is used to extend an opening of a hive housing. Connected to the body are an inlet and an outlet which, respectively, permit bees from the environment (e.g., ambient air) to enter the cavity, and permit bees from within the cavity to exit into the environment. Within the cavity, a surface for receiving an additive is placed proximate to an expected incoming path travelled by bees entering the cavity via the inlet. As bees travelling towards the inlet typically proceed into the hive, in this way bees travelling the expected incoming path collect a desired substance (e.g., via adhesion to the bee body) and transport said substance to the hive. The substance can be selected to have beneficial health properties to the colony (e.g., oxytet which is an antibiotic for the treatment of European and American Foulbrood).

The inspenser apparatus includes a deflector preventing bees travelling along the expected incoming path from exiting through the outlet. In this way, the disclosed inspenser can allow for the appropriate dosage of health promoting substances to be apivectored to increase health outcomes within the colony, while minimizing waste of materials into the environment.

The inspenser apparatus may include a lip (e.g., a protrusion, edge, etc., on the back of an inlet shelf, as described further below) on the surface provided with the substance. In this way the disclosed inspenser may prevent waste of the substance by ensuring that the substance is disseminated throughout the hive by returning foragers and not removed from the colony by housekeeper bees.

The inspenser apparatus may include one or more protrusions (e.g., a guide, a rail, a block, etc.) within the cavity to guide bees travelling along the expected incoming path to interact with the surface providing the substance. The protrusion also acts as an obstacle to prevent bees from removing the substances into the environment.

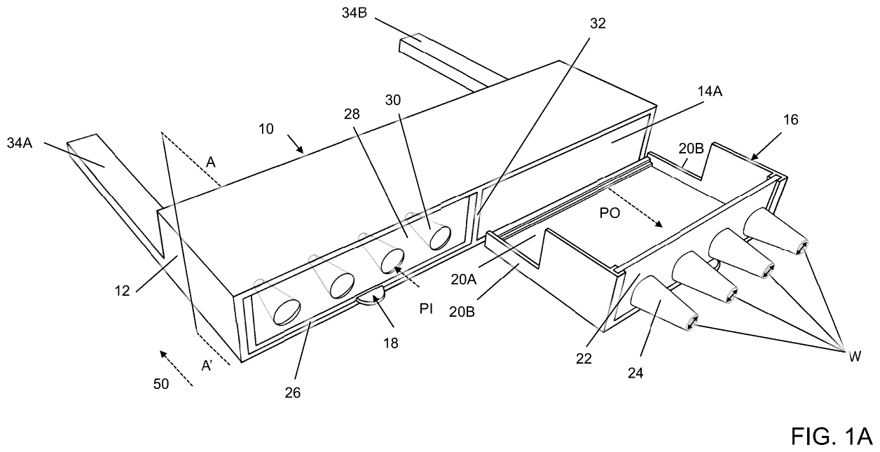

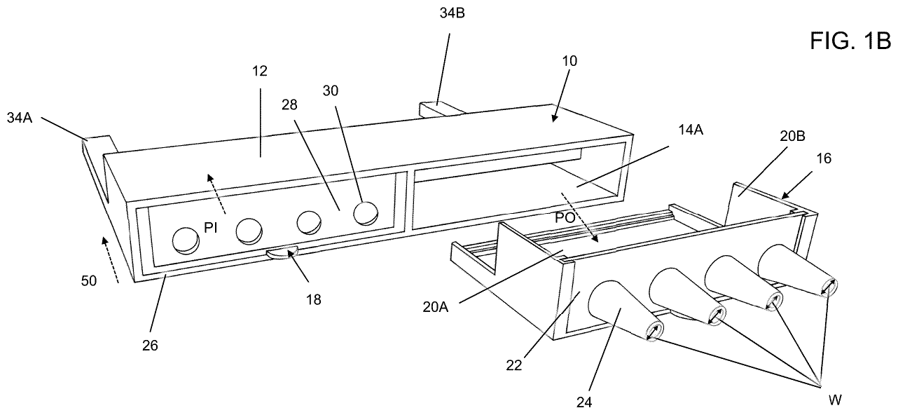

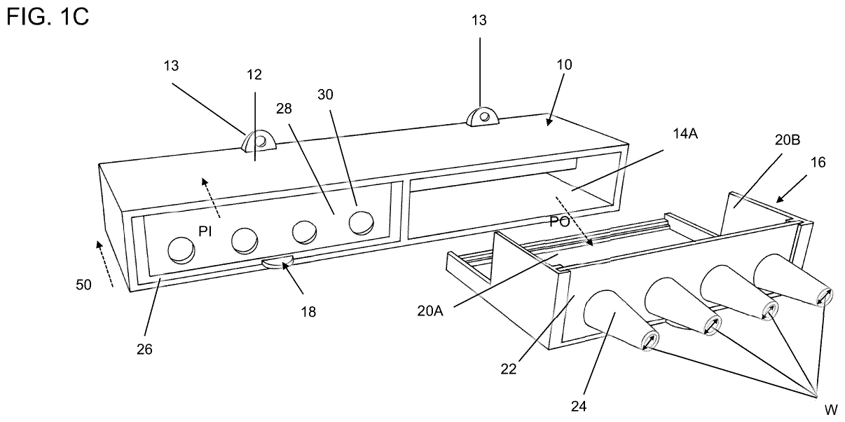

In example embodiments, the inspenser apparatus may include one or more elongated members for engaging with the opening in the hive housing. Advantageously, this may allow for the disclosed inspenser apparatus to be used in retrofitting applications with existing hive housings. Moreover, the elongated members may increase ease-of-use and/or portability of the system by allowing for relatively easy removal of the inspenser apparatus. Alternatively, tabs (e.g., the tabs 13 shown in FIG. 1C) can be used to affix the inspenser directly to the hive with screws or hooks.

Such an inspenser apparatus may keep away other pests (e.g., skunks) from getting into the hive, or the length of the disclosed inspenser can increase the landing board side to allow for the bees to fan and cool the hive even better.

In further illustrative example embodiments, during a phase of operation, a mesh blocker can be used in place of an outlet or inlet, which can advantageously be used on one side of the disclosed inspenser to lure robbers away from the inlet 18, and make it easier for bees to defend the hive as wasps tend to go by smell and it would be easier for the bees to guard smaller entrances created by the mesh insert.

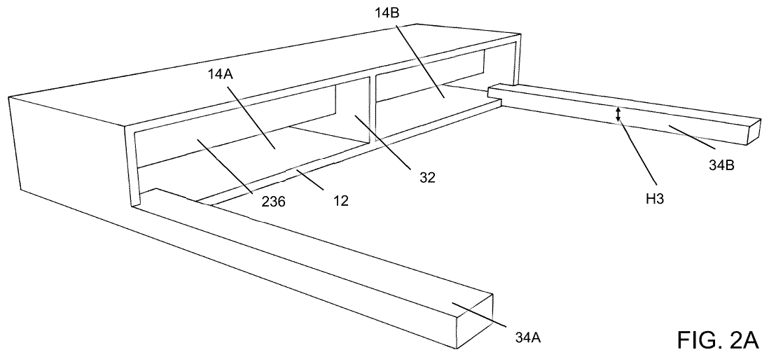

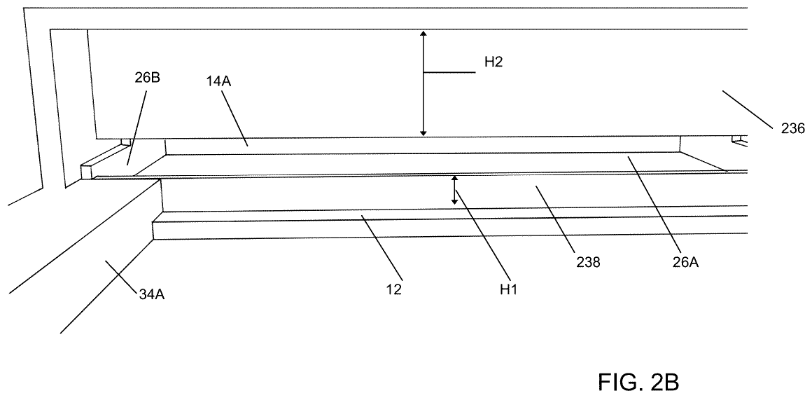

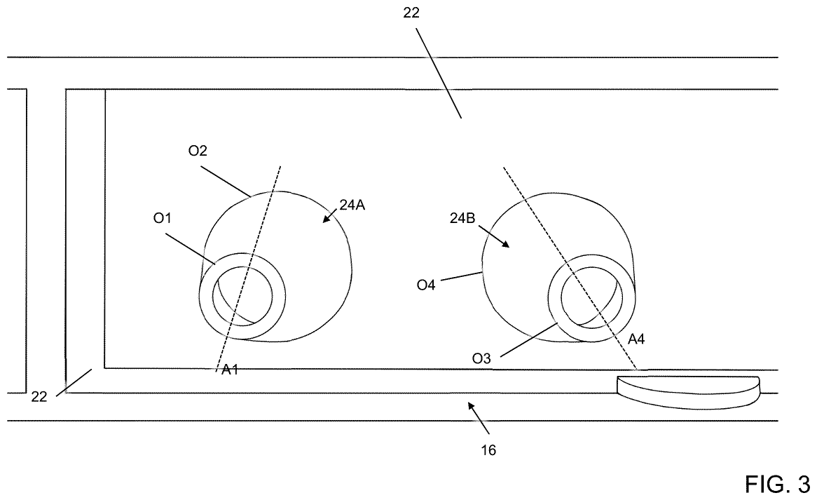

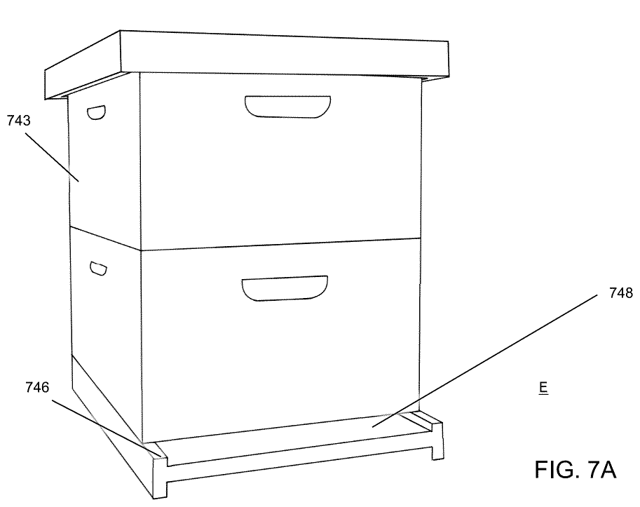

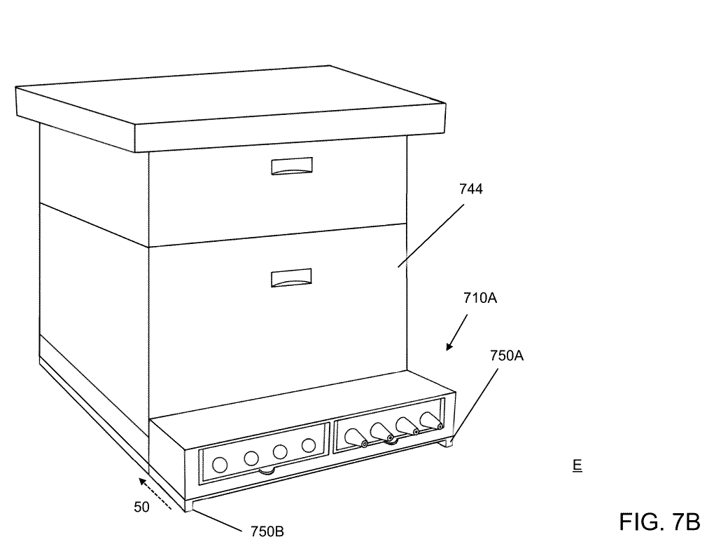

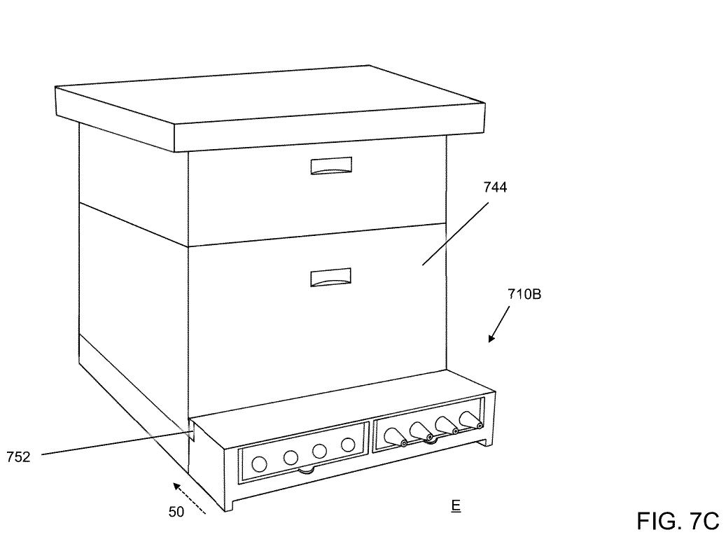

Turning now to the figures, FIGS. 1A, 1B, 2, and 3 show various views of example inspenser 10. Inspenser 10 includes body 12 which defines one or more channel(s) 14 (hereinafter to be referred to in the singular for ease of reference) for fluid communication with the hive entrance (e.g., opening 748 in FIG. 7A) of a hive housing (e.g., hive housing 744 in FIG. 7A). For example, body 12 may be positioned so that a rear of channel 14, shown in FIGS. 2 and 3, extends across the width of the opening. In example embodiments, body 12 contains one or more cavities, which cavities define the one or more channel(s) 14 in fluid communication with the opening.

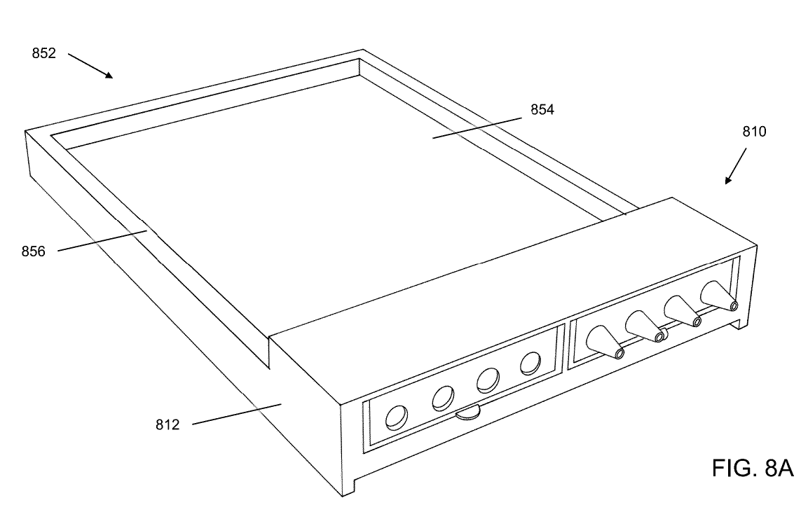

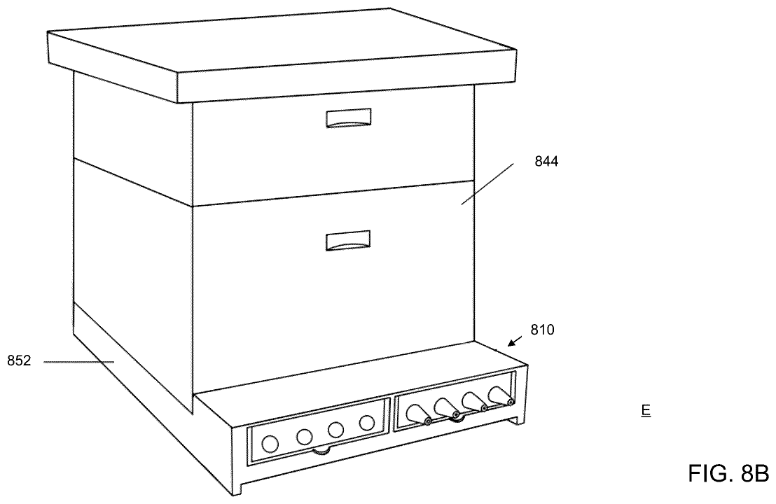

Channel 14 permits bees to travel either into the hive housing from the environment (e.g., ambient air E as shown in FIGS. 7A and 8A) or into the environment from the hive housing. Hereinafter, bees travelling or moving along through channel 14 out of the hive housing can be referred to as travelling along an expected outgoing path (for example, path PO in FIG. 1A, 1B), and bees travelling or moving along through channel 14 into the hive housing can be referred to as travelling along an expected incoming path (for example, path PI in FIG. 1A, 1B). It is contemplated that the expected incoming path and the expected outgoing path can include any number of paths travelled by individual bees, including non-linear paths. Body 12 can be white or a light color to prevent overheating of bees within the channels, or to prevent heat accumulation near the beehive.

In the embodiment shown, inspenser 10 includes a deflector 32 positioned within channel 14 between outlet 16 and inlet 18. Deflector 32 impedes (e.g., partially or wholly) bees travelling along the expected incoming path from entering or changing direction into or otherwise travelling along the expected outgoing path or moving added substances between cavities. For example, in the shown embodiment deflector 32 is a vertical wall which spans the full depth of body 12, dividing channel 14 such that deflector 32, along with body 12, defines two separate channels 14A, 14B. It is contemplated that the body 12 can include more than one deflector 32 defining two or more channels 14 in body 12. In example embodiments, deflector 32 does not divide the body into separate channels (e.g., deflector 32 does not span the entire length of body 12), or is movable within body 13 to redefine the geometry and/or paths of the channels or is removable.

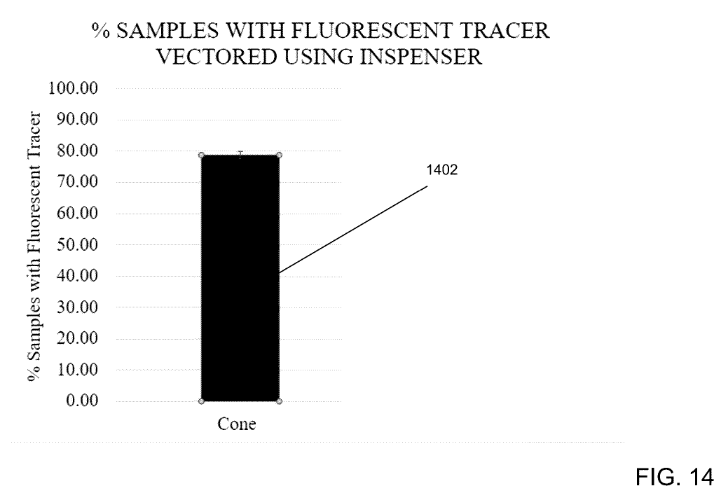

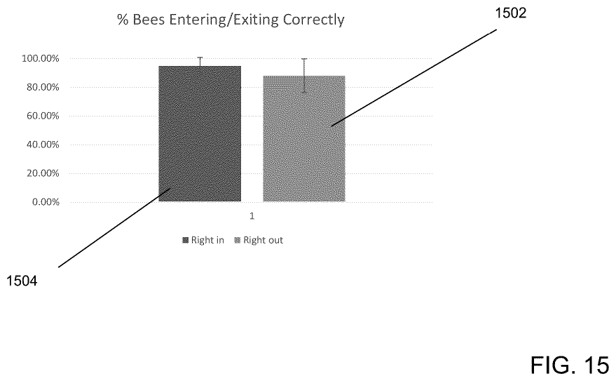

Channels 14A and 14B are further, respectively, defined by outlet 16 and inlet 18. Outlet 16, shown in a disassembled configuration outside of or removed from channel 14 in FIG. 1, includes part 22 which is shown one or more conical passages 24 (hereinafter referred to in the singular for ease of reference). In preferred embodiments, part 22 includes at least three conical passages 24, as fewer conical passages 24 may result in bearding of bees. In an assembled configuration, conical passage 24 permits bees' movement from within the channel 14 (e.g., from the opening) to an outside environment. Experimental data, as shown in FIGS. 14 and 15, indicates that bees are more likely to exit channel 14 via outlet 16 owing to the wider opening of conical passage 24 being accessible from within channel 14. The experiments also indicate that bees are more likely to avoid entering channel 14 from the environment via conical passage 24 as a result of the narrow opening of conical passage 24 facing bees travelling along the expected outgoing path. Similarly, inlet 18 includes part 28 which is shown with at least one conical passage 30 (hereinafter referred to in the singular for ease of reference). In preferred embodiments, part 28 includes at least three conical passages 30, as fewer conical passages 30 may result in clumping of bees. Conical passage 30 permits bees' movement from the outside environment into channel 14. Similar to conical passage 24, bees may be more likely to enter channel 14 via inlet 18 owing to the wider opening of conical passage 30 observed by bees travelling the expected outgoing path. Similar to conical passage 24, bees may be more likely to avoid exiting channel 14 into the environment via conical passage 30 as a result of the narrow opening of conical passage 30 facing bees approaching inlet 18 from within channel 14. Experiments indicate that other shapes may not be as effective at providing the right dose of substance and facilitating bees going in and out if the hive via the expected incoming path and the expected outgoing path. Moreover, the inspenser 10 can minimize wasteful removal of the substance. Conical passage 30 and conical passage 24 can be defined by walls having different frictional characteristics. For example, the inner walls (e.g., facing axis A3) of conical passage 30 can include a frictional surface that, when walked upon by bees, generates a frictional force greater than a frictional force associated with bee slippage, so as to avoid discouraging bees from walking along such walls and into the cavity 14. In contrast, the outer walls (e.g., opposite axis A3) of conical passage 30 can be smoother than the inner walls to discourage bees from trying to enter the environment via inlet 18. The conical passage 24 can include a similar configuration. Conical passage 30 and conical passage 24 can be red, such that bees have difficulty seeing the walls defining conical passages 24 or 30 and therefore enter through the larger opening of the respective conical passage. Conical passage 30 and conical passage 24 can also prevent the queen bee from leaving the hive by having openings too small for the queen bee to pass through.

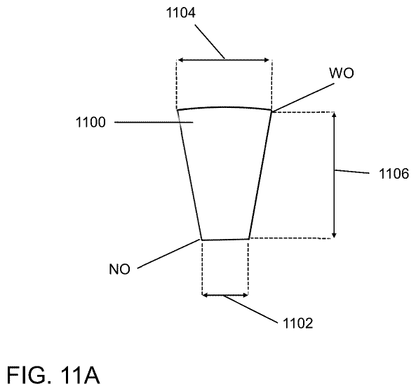

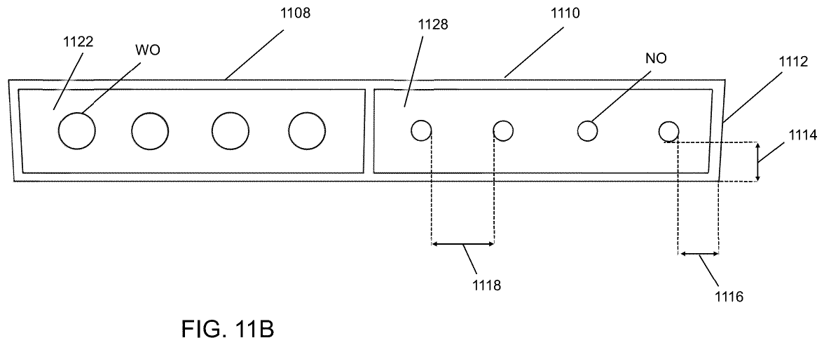

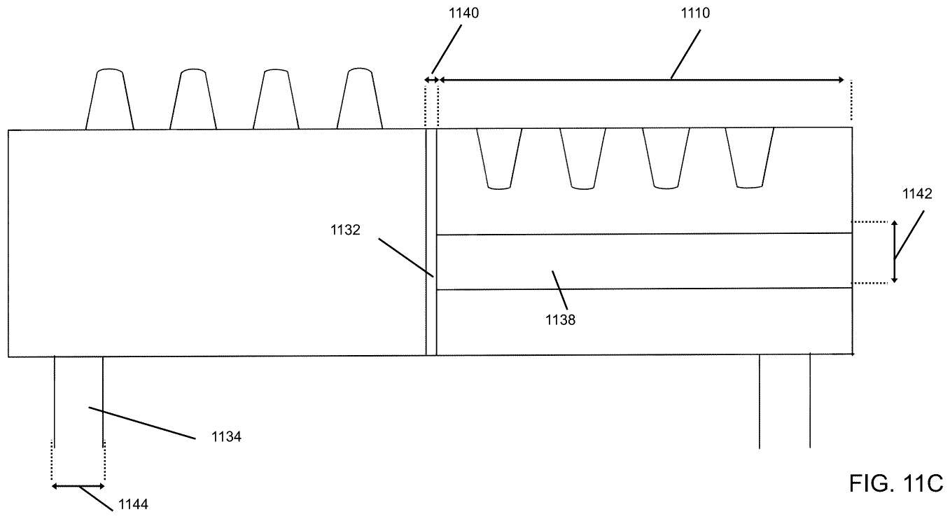

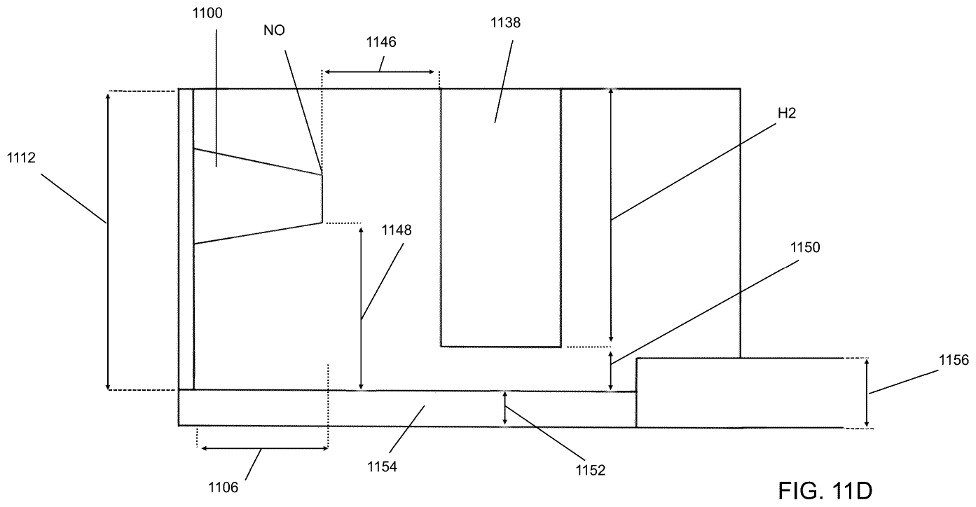

Referring now to FIG. 3, a front view of an outlet 16 is shown. Conical passage 24A includes an opening O1 and a larger opening O2, with O2 being between the hive housing and O1. Openings O1 and O2 are centered along axis A1, which in the shown embodiment is parallel to the sides of part 26. Similarly conical passage 24B includes an opening O3, and a larger opening O4, with O4 being between the hive housing and O3. Similar to conical passage 24A, openings O3 and O4 are centered along axis A2 which is parallel to the sides of part 26. The parallel passages of outlet 16 may advantageously discourage honeybees walking from one conical passage 24 to another, as compared to non-parallel conical passages 24. Similarly, spacing the openings O1 and O3 a minimum distance (e.g., distance 118 of FIG. 11B) that prevents bees from standing on, for example, opening O1, and being able to reach over or extend, without flying, to opening O3, can prevent bees from walking between conical passages and impeding other bees travelling along the expected outgoing path. In example embodiments, axes A1 and A2 may not be parallel, and instead increasingly approach or diverge from one another in a direction 50 (FIG. 1), towards the hive housing or otherwise have non-parallel axes. Alternatively stated, the axes A1 and A2 can approach one another towards the hive end of the channel 14, where the hive end of the channel 14 is defined as the portion of the channel 14 closest to the hive housing in an installed configuration. It is contemplated that the axes can be parallel and/or almost orthogonal to the sides of part 26, intersect or fail to intersect, or that they can increasingly diverge in direction 50.

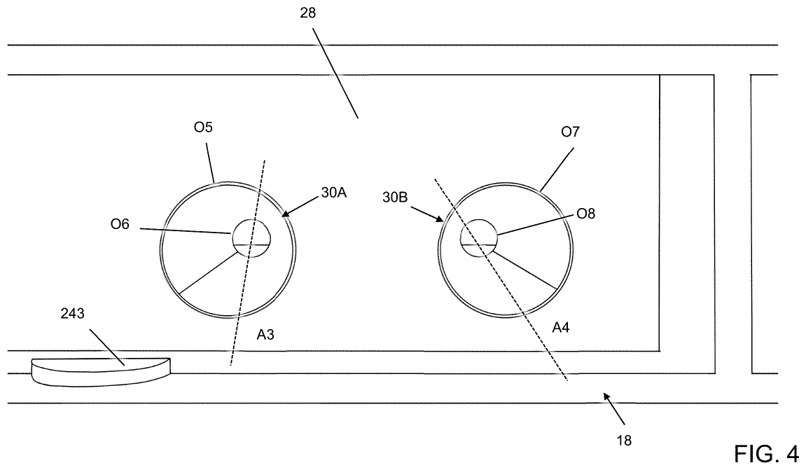

Inlet 18, shown in part in FIG. 4, includes conical passages 30A and 30B, having, respectively, opening O5 and opening O6, and opening O7 and opening O8. Opening O6 has a smaller diameter compared to opening O5 and is positioned between the hive housing and O5. Opening O8 has a smaller diameter compared to opening O7, and is positioned between the hive housing and O7, and can be within channel 14. Openings O6 and O5 are centered along axis A3, which in the shown embodiment is parallel to the sides of part 28. Similar to conical passage 30A, openings O8 and O7 are centered along axis A4 which is parallel to the sides of part 28 (e.g., axes A3 and A4 are parallel). The parallel passages of inlet 16 may advantageously discourage honeybees walking from one conical passage 30 to another, as compared to non-parallel conical passages 30. Similarly, spacing the openings O6 and O8 a minimum distance apart that prevents bees from standing on, for example, opening O6, and being able to reach over or extend, without flying, to opening O8, can prevent bees entering through the exit pathway. This is also true on the incoming pathway to keep the bees from exiting from within channel 14 through the openings of outlet 16, whose conic passages are configured with a minimum spacing. The minimum distance (e.g., distance 1118 of FIG. 1B) between the conical passage 30 openings may also prevent honeybees from performing U-turns seeking to enter channel 14 via one conical channel 30 and exit via a separate conical channel 30. In example embodiments, axes A3 and A4 may not be parallel, and can increasingly diverge from or approach one another in direction 50 towards the hive housing or otherwise have non-parallel axes. Alternatively stated, the axes A3 and A5 may diverge from one another towards the hive end of the channel 14. This configuration may advantageously congregate bees entering the beehive. It is contemplated that the axes can be parallel and/or orthogonal to the sides of part 28, intersect or fail to intersect, or closer to one another when measured at openings O5 and O7 as compared to when measured at openings O6 and O8.

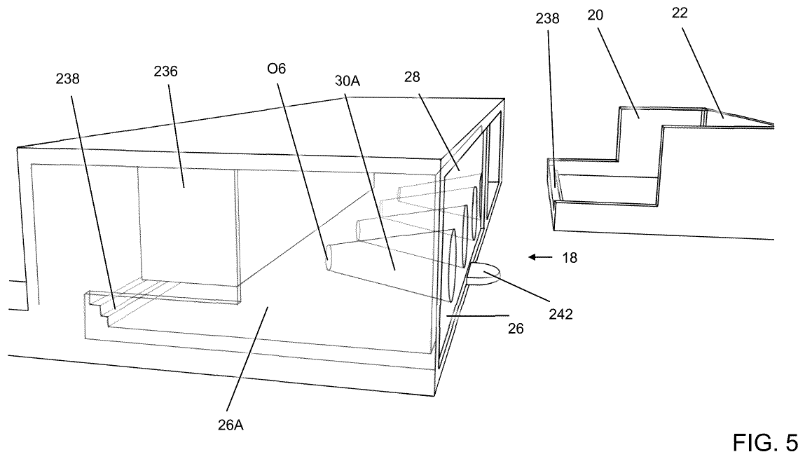

Referring now to FIG. 5, outlet 16 and inlet 18 can be removable from body 12. For example, outlet 16 can include side walls 20B, base 20A, (e.g., a shelf part 20), which in an assembled configuration interact with one or more of the interior side walls of body 12 and/or deflector 32 to maintain outlet 16 in an inserted position within body 12. Similarly, inlet 18 can include side walls 26B (FIG. 2B) and base 26A which in an assembled configuration interact with one or more of the interior side walls of body 12 and/or deflector 32 to maintain inlet 18 in an inserted position within body 12. In example embodiments, the sidewalls of outlet 16 or inlet 18 are positioned within channel 14, (e.g., via and part 22 and part 28) prevent rotation or displacement of outlet 16 or inlet 18 relative to body 12 as a result of interaction with the sidewalls of body 12. Outlet 16 and inlet 18 can include tabs 242, beneath conical passage 24 and conical passage 30, to aid in removing outlet 16 and inlet 18 from body 12. Tabs 242 are further located a minimum distance from conic passages 24 so as to prevent bees from standing upon, or otherwise facilitate bees utilizing tab 242 to reach or enter the smaller openings of conic passage 24, disrupting the flow of bees.

Within channel 14, and proximate to the expected incoming path of bees travelling through inlet 18 is a surface (e.g., surface 26A in FIG. 2B) provided with an additive. The surface can be proximate to the expected incoming path where the surface is closer to inlet 18 as compared to the outlet 16, in the same channel 14 as inlet 18, and close enough so that bees travelling along the expected incoming path can land on or walk along the surface. The surface can be surface 26B of inlet 18, or a surface of body 12 (not shown), or a surface of another part inserted into channel 14 (e.g., a board inserted into channel 14).

The additive can be a powder or liquid which adheres to or otherwise clings to bees upon touch or proximity. The additive can be an antibiotic, probiotic, miticide, biological control agent, or other additive which aids in protecting bees and beehives from pests and disease. In example embodiments, the additive can be a food, such as a pollen patty. Embodiments where, for example, the additive in a first phase of operation is an antibiotic and in a second phase of operation is a food are contemplated. Bees which accrue the additive travelling the expected incoming path in the channel 14 can subsequently deposit same within the hive.

The surface can include one or more lips, downstream of the inlet relative to the expected incoming path, to contain the additive as well as inhibit removal of the additive from the hive or channel 14. For example, referring to again to FIGS. 1 to 3 and 5, lip 238, located on surface 26A between conical passage 30 and the hive housing, prevents bees landing on surface 26A from dragging or kicking or otherwise physically dispersing additive over an edge of surface 26A. Lip 238 may also prevent waste of the substance by ensuring that the substance is disseminated throughout the hive by returning foragers and not removed from the colony by housekeeper bees. Each of parts 26 and 20 can include a lip such as lip 238, and collectively the lips may prevent the housekeeping bees from moving the additive out of the hive. Lip 238 can be removable from inlet 18, such that different sized lips can be installed depending on the desired configuration of the inspenser 10.

Body 12 can include one or more protrusions 236 (referred to in the singular hereinafter) to deflect bees towards the surface containing the additive. Protrusion 236 can be downstream of inlet 18 relative to the expected incoming path and can be a minimum distance (e.g., as shown in FIG. 11C) from the end of conic passage 30 of inlet 18 so as to dissuade bees from entering the inlet 18 via the conical passage 30. In an example embodiment, distance is fixed so that protrusion 236 impedes the ability to the honeybee to go through opening O6 exit channel 14 via the inlet 18, as the honeybee has difficulty in reaching opening O6 from within channel 14. Protrusion 236 may also be positioned so as to be not too close to opening O6 to avoid bees exiting O6.

Protrusion 236 in FIG. 5 is shown above surface 26A and between the conical passage 30 and hive housing, and guides bees towards the surface 26A. Protrusion 236 has height H2 (FIG. 2), which can be sized to force bees to walk along at least a portion of surface 26B to pass through channel 14, ensuring that the additive adheres to the bees travelling along the expected incoming path. Alternatively, protrusion 236 can have a height H2, creating a gap between protrusion 236 and surface 26A (e.g., distance 1150 in FIG. 11D), which prevents bees from walking along a surface of protrusion 236 opposite the surface 26A without interacting with the additive. In example embodiments, protrusion 236 can be downstream of inlet 18 and upstream of lip 238 relative to the expected incoming path, with H2 and H1 of the protrusion 236 and lip 238 guiding bees to be proximate to surface 26A under the protrusion 236, and to subsequently track the powder into the hive.

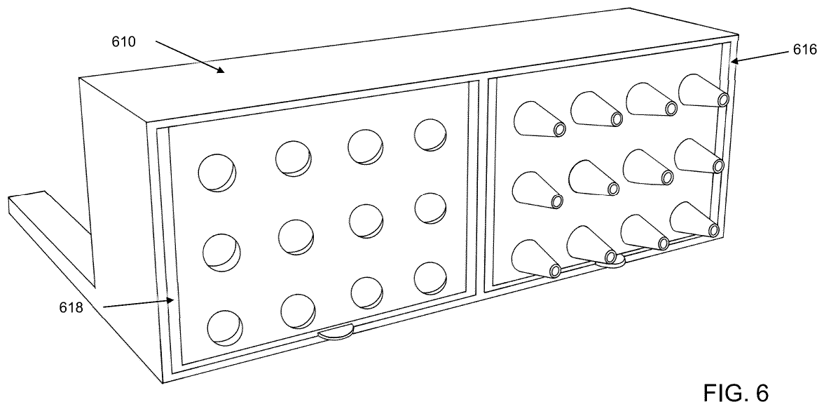

In the embodiment shown in FIG. 6, outlet 616 and inlet 618 of inspenser 610 include a plurality of conical passages arranged in a grid formation or otherwise in an array. The conical passages can be arranged in a non-uniform manner or differ in arrangement between outlet 616 and inlet 618. Various arrangements of the conical passages are contemplated, and preferably the following conditions are satisfied: (1) the protrusion of the inspenser is far enough (e.g., a minimum distance) from the small openings in the conical passages, (2) the top most or highest conical passage is far enough from a top surface of the body within the channel, so as to prevent bees walking along the body surface into the conical passage, (3) the bottom or lowest conical passage is similarly far enough from a base of the inlet/outlet, again to prevent bees walking along the base into the conical passage, and (4) each conical passage is far enough from other conical passages to prevent bees walking between same.

Referring to FIGS. 1A and 1B, inspenser 10 can further include elongated members 34A and 34B, which in an assembled configuration interact with walls of the hive housing defining the opening to position channel 14 to enable fluid communication with the opening. Referring now to FIG. 7A, hive housing 743 is shown placed on top of bottom board 746 and together they define opening 748. Bottom board 746 can be integrated with hive housing 743, or can be a separate structural member made of, for example, wood. FIG. 7B shows a conceptual depiction of the hive housing 743 of FIG. 7A in fluid communication with an example inspenser. In the assembled configuration of FIG. 7B, elongated members 34A and 34B (not shown) of inspenser 710A extend into and interact with walls defining an opening, similar to opening 743, of the hive housing 744 to position inspenser 710A such that the rear portion of channel 14 is in fluid communication with opening 748. For example, elongated members 34A and 34B have a height H3 (FIG. 2A) such that they interact with an upper wall defining opening 748, or they can be sized to interact with the sidewalls of opening 748 to friction fit through opening 748. Inspenser 710A further includes one or more legs (shown in FIG. 7B as legs 750A, 750B) to maintain a relative position between inspenser 710A and opening 748. In the illustrative embodiment shown in FIG. 7C, inspenser 710B is attached to the hive housing 744 and bottom board 746 via fastener 752, which can be a removable, or a permanent fastener, or an adhesive based fastener, clamp, or otherwise. FIG. 1C shows an alternative implementation, wherein tabs 13 are used to fasten the inspenser 10 to the front side of the hive housing with a fastener. Fastener 752 can be permanently attached to inspenser 710B and removably attached to hive housing 744, or fastener 752 may be separate from the inspenser 710B and hive housing 744 (e.g., a mounting bracket and screws).

According to another aspect, as shown in FIGS. 8A and 8B, inspenser 810 includes a platform 852 for supporting hive housing 844 as part of body 812. Platform 852 includes one or more support members 856 and recess 854, and when the hive housing is resting on support members 856, the hive opening aligns with a channel of the inspenser 810. In the assembled configuration, hive housing 844 rests on platform 852 of inspenser 810 such that, where inspenser 810 is assembled with an inlet and outlet in place, bees can only enter or exit the hive housing 844 via the channel (not shown), inlet and outlet of inspenser 810.

In FIGS. 1A and 1B, inspenser 10 can further include elongated members 34A and 34B, which in an assembled configuration interact with walls of the hive housing defining the opening to position channel 14 to enable fluid communication with the opening.

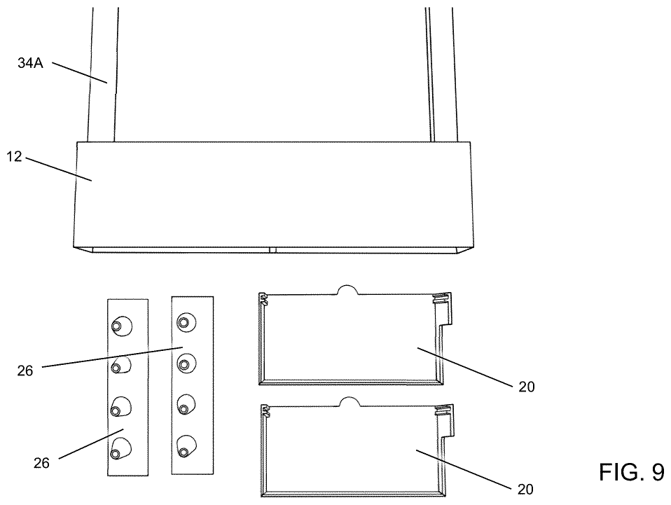

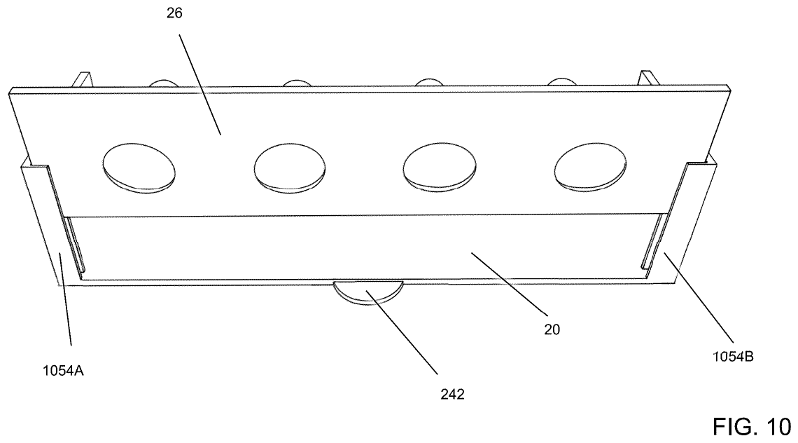

Inspenser 10 can be at least in part be capable of disassembly, for example to replace worn parts, nesting storage, ensure ease of transportation, to allow for configurations responsive to individual environments (e.g., different bee sizes, wind conditions, etc.), to provide additive to the surface proximate inlet 18, and so forth. In the example shown in FIGS. 9 and 10, outlet 16 can be disassembled into two parts, shelf part 20 interacting with body 12, and part 26 which includes the conical passages. Part 20 includes attachment means for securing part 26 in place (e.g., the shown grooves 1054, 1054B).

FIGS. 11A to 11D show various views of a preferred embodiment of an example inspenser. It should be noted that FIGS. 11A to 11D are not shown to scale, with some features exaggerated for ease of reference.

As shown in the figures, in the preferred embodiment, the openings NO of the conical passages 1100 (i.e., the wider conical passage openings) have width or diameter 1102 (FIG. 11B), where each narrow opening is the width of a single bee head (e.g., 7-7.2 mm for North American honeybees). This in part prevents bees from using openings of the conical passages as both an inlet and outlet. The openings WO (the wider openings) have width or diameter 1104 of approximately 19 mm. Each conic passage 1100 has a length or depth of 1106 of approximately 30 mm. As shown in FIG. 1B, part 1122 of the preferred inlet has width 1008, and part 1022 of the preferred outlet has width 1110, with both width 1108 and 1110 being 125.65 mm. Parts 1122 and 1128 also have a height 1112 of 48 mm. The distance 1114 between the bottom of opening NO and the bottom edge of part 1128, shown as distance 1116, is 6.25 mm, the distance between two conic passage openings NO of part 1128 is 17-19 mm (denoted by distance 1118). Referring to FIG. 11C, deflector 1132 is 62.2 mm wide (denoted by width 1140), protrusion 1138 is 23.96 mm deep (denoted by depth1142), and the width of elongated portion 1134 is 30.17 mm (denoted by width 1144). FIG. 11D shows distance 1146 between opening NO of conical passage 1100 and protrusion 1138, which in a preferred embodiment is approximately 10 mm. Distance 1148 between the surface and the protrusion 1138 in a preferred embodiment is also approximately 10 mm. Protrusion 1138 has a protrusion, which can be 27 mm, so that the bottom edge of protrusion is a distance 1150 from the surface (e.g., approximately 14 mm in the preferred embodiment). The base 1154 of the part can have a thickness 1152, which in the preferred embodiment is 4 mm, and the shown lip can have a height of 14 mm.

The preferred embodiment set out herein is preferred where honeybees widely used in North America are the intended target of the inspenser. In other geographies, or different applications which include different sized bees, corresponding adjustments can be made to the dimensions of the inspenser based on the teachings herein. Moreover, the preferred embodiment lists minimum values for distances between features, and, for example, the conical passages may be longer, the protrusion may be thicker, and so forth. Although listed as specific values, it is understood that variations to the dimensions shown is acceptable for the preferred embodiment.

The preferred embodiment, based on experimental data, allows for effective control of the dosage of additive delivered to the hive. With the preferred embodiment, various dosages can be used to prevent harmful overdosing of the bees, or ineffective underdosing. In example embodiments, during an example phase of operation, inspenser 10 can be assembled to include outlet 16 and inlet 18 having conical passages 24, 30. In a further phase of operation, for example, outlet 16 can be assembled to include part 24 having conical passage 30, with the narrower portion of conical passage 30 being within channel 14. The further phase of operation can be used to encourage bees to enter the hive, and to discourage bees from exiting the hive. For example, the further phase can be used to decrease bee flight before pesticide application to crops, before or during mowing, before or during gatherings, or in circumstances where concerns with swarming are expected. It is contemplated that inspenser 10 can be disassembled and reassembled. The inspenser 10 can be reassembled so that a blocker (not shown) prevents travel through conical passages 24, 30. For example, the blocker can be a board sized to block the wide openings of conical passages 24, 30. In a preferred embodiment, the blocker is a solid rectangle with a small opening either 1⅜ inches or 3 and ⅜ inches that is used in place of outlet 16. Other inserts will allow for further implementations of entrance size reducers in response to weather and/or robbing. For example, the blocker may be a mesh insert, used in place of either the inlet 18 or the outlet 16, to lure robbers away from the insert (e.g., wasps tend to go by smell and with appropriate mesh sizing it would be easy for the bees to guard the smaller entrances in the mesh blocker as compared to the openings of the inlet 18 on the other side).

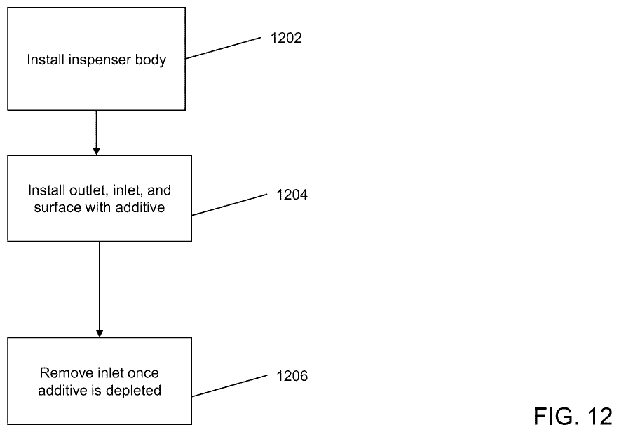

Referring now to FIG. 12, a block diagram for an example method of configuring an example inspenser is illustrated, with reference to FIGS. 2 and 7B. At step 1202, the inspenser body 12 is installed to establish fluid communication with the opening 748, for example as shown in FIG. 7B. At step 1204, the inlet 18 and outlet 16 is installed into body 12, with additive provided on base 26A of inlet 18. Additive can be added to the surface either before installation, or after inlet 18 is partially installed into body 12. At step 1206, once additive has been dispersed from the surface, the inlet 18 and outlet 16 are removed. Removing the inlet 18 and outlet 16 can alleviate ventilation concerns as a result of possible reduced airflow or heating or avoiding bees clustering around the openings. This method, as described herein in relation to example phases of operation, encourage bees to disperse additive into the hive housing.

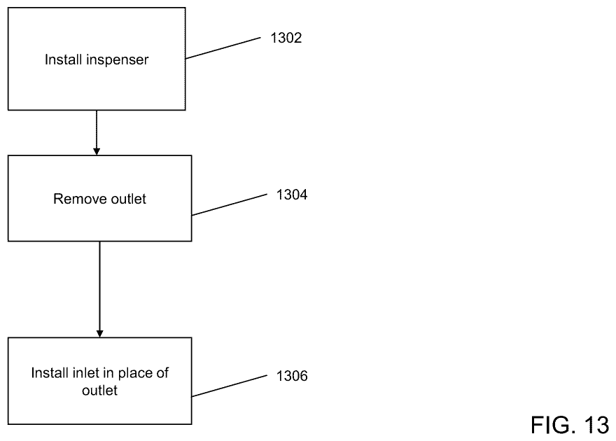

Referring now to FIG. 13, a block diagram for an example method of configuring an example inspenser is illustrated. At step 1304, the inspenser, including the outlet, inlet and surface, is installed to establish fluid communication with the hive housing, for example as shown in FIG. 7B or 8B. At step 1304, the outlet is removed from the inspenser, for example by pulling tab 242. At step 1306, a second inlet, for example an inlet substantially similar to inlet 18, is inserted into the inspenser in place of the outlet. This method, as described herein in relation to example phases of operation, encourage bees to enter the hive housing.

In example embodiments, a surface proximate to outlet 16 (e.g., surface 20A, reference to hereinafter as the dispersion surface), similar to the surface proximate to inlet 18, is provided with an additive beneficial for plant life in the environment. The additive, once carried by bees travelling along the expected outgoing path to the environment, is dispersed on plants the bees interact with and may positively impact the plant life. The additive can be a crop protectant, such as Botanigard, Bacillus thuringiensis, or Prestop. The body 12 proximate to the dispersion surface can similarly include protrusion 238 to steer bees towards the dispersion surface. In example embodiments, for modularity, inlet 18 can be reassembled to include conical passages 24, and the surface proximate to inlet 18 can become the dispersion surface and include lip 238.

FIG. 14 shows a graph of experimental data of additive within an the preferred inspenser being moving into a hive. As is shown by bar 1402, 80% of tested cells within a honeybee hive contained the additive after apivectoring using the inspenser. This experiment used fluorescent powder combined with the diluent powder as the additive, and results were measured after 24 hours by cutting out 3 cells (one hexagon is a cell) from multiple frames and quadrants. After washing the cells 1% of the resuspended volume was microscopically analyzed for fluorescent powder, and 80% of samples were positive for fluorescent powder.

FIG. 15 shows a graph of experimental data of bees moving in and out of the hive via the preferred inspenser. As shown by bars 1502 (bees correctly leaving outlet 16), and 1504 (bees correctly entering through inlet 18), more than 87% of bees used the expected incoming and outgoing paths for ingress/egress.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims

1. An inspenser for delivering additive via bees, the inspenser operable with a hive housing comprising an opening, the inspenser comprising:
a body having one or more channels for fluid communication with the opening;
an inlet and an outlet each permitting movement of bees between an environment and the one or more channels;
a surface for receiving an additive, within the one or more channels, the surface being proximate to an expected incoming path travelled by bees entering the one or more channels via the inlet;
a deflector, positioned between the inlet and the outlet, inhibiting bees moving along the expected incoming path from entering the outlet.

2. The inspenser of claim 1, wherein the inlet includes the surface.

3. The inspenser of claim 1, wherein the surface includes a lip for preventing additive dispersion.

4. The inspenser of claim 1, wherein the inlet and the outlet include, respectively, one or more conical passages, the inlet conical passages narrow along a direction defined by the expected incoming path.

5. The inspenser of claim 4, wherein the outlet conical passages at least in part narrow away from the direction defined by the expected incoming path.

6. The inspenser of claim 4, wherein a size of an opening of the inlet conical passages is an expected size of a head of the bee.

7. The inspenser of claim 4, wherein the one or more conical passages of the outlet are parallel to the one or more conical passages of the inlet.

8. The inspenser of claim 1, wherein the at least part of the inlet is red.

9. The inspenser of claim 1, wherein the body further comprises one or more protrusions into the one or more channels guiding the bees towards the surface.

10. The inspenser of claim 9, wherein the protrusions are a minimum distance from an opening of the conical inlet passages to prevent the bees from exiting via the inlet.

11. The inspenser of claim 4, wherein the conical passages of the inlet are spaced apart to prevent bees from walking from one opening of one conical passage into an adjacent opening of an adjacent conical passage.

12. The inspenser of claim 11, wherein there are three inlet conical passages.

13. The inspenser of claim 1, wherein the body further comprises one or more elongated members;
wherein in an assembled configuration the one or more elongated members interact with walls defining the opening to position the inspenser to enable fluid communication between the opening and one or more channels.

14. The inspenser of claim 1, wherein the inlet and the outlet are removably connected to the body.

15. The inspenser of claim 14, wherein the inlet and the outlet are shelves which are insertable into the one or more channels.

16. The inspenser of claim 1, further comprising one or more legs for positioning the inspenser to enable fluid communication between the opening and one or more channels.

17. The inspenser of claim 1, wherein the body further comprises one or more protrusions into the one or more channels guiding the bees towards the surface.

18. The inspenser of claim 17, wherein the one or more protrusions are between a lip of the surface and the inlet, guiding bees from the inlet towards the surface while permitting bees to fly from the surface over the lip.

19. An apparatus for managing bees of a hive housing having an opening, the apparatus comprising:
a body including a cavity in fluid communication with the opening;
an inlet and an outlet, opposite the opening, respectively permitting movement of bees from ambient air into the cavity and permitting movement of bees from the opening out of the cavity;
a surface for receiving an additive, the surface proximate to the inlet, wherein the surface includes a lip downstream of the inlet relative to the expected incoming path.

20. A method for managing bees associated with a hive housing, the hive housing comprising at least in part an opening, the method comprising:
installing an inspenser for fluid communication with the opening, the inspenser including an inlet and an outlet in removably inserted into the inspenser;
removing the outlet from the inspenser;
inserting a second inlet into the inspenser for encouraging bees to enter the hive housing.
